(19) United States
(12) Patent Application Publication
(10) Pub. No.: US 2025/0217425 A1
(43) Pub. Date: Jul. 3, 2025

(54) Method and System for an Intelligent Search Engine

(71) Applicant: Elevance Health, Inc., Indianapolis, IN (US)

(72) Inventors: Krishna Chaitanya Gollapudi, Hyderabad (IN); Prateek Srivastava, Hyderabad (IN); Santosh Reddy Singireddy, Hyderabad (IN); Atchuta Sai Kumar Vasantavada, Hyderabad (IN); Moova Nageshwara Rao, Hyderabad (IN)

(73) Assignee: Elevance Health, Inc., Indianapolis, IN (US)

(21) Appl. No.: 18/987,120

(22) Filed: Dec. 19, 2024

Related U.S. Application Data
(60) Provisional application No. 63/615,431, filed on Dec. 28, 2023.

(51) Int. Cl. G06F 16/9535; G06F 16/901; G06F 16/9538; G06F 40/279; G06F 40/30

(52) U.S. Cl. CPC G06F 16/9535; G06F 16/9024; G06F 16/9538; G06F 40/279; G06F 40/30

(57) ABSTRACT

Systems, methods and interfaces are provided for processing natural language queries. A machine learning-powered search interface may process complex natural language queries across specialized domains. The method may utilize a transformer-based natural language processing model that analyzes user intent by examining both current and historical user inputs. A graph data structure may be used to represent interconnected domains like patient records, insurance claims, and business metrics enables dynamic information retrieval. The system may use an A* search algorithm to navigate domain nodes and identify relevant answers. An abbreviation expansion mechanism resolves technical shorthand by referencing domain-specific mapping databases, ensuring precise interpretation of user queries. The method may identify keywords, traces optimal answer pathways, and adapt by updating graph relationships and abbreviation mappings. By generating contextually rich natural language summaries, the system delivers precise, comprehensive responses through an intuitive search interface.

### RELATED APPLICATIONS

This application claims priority to U.S. Provisional Application No. 63/615,431, titled “Method and System for an Intelligent Search Engine,” filed Dec. 28, 2023, which is hereby incorporated by reference in its entirety.

### TECHNICAL FIELD

The disclosed implementations relate generally to chatbots and relate more specifically to generating accurate chatbot front end responses to user queries of a search engine.

### BACKGROUND

Chatbots are automated chat interfaces where a user can type a question or another kind of query, and receive an answer from an automated system, in an interface that mimics interaction with another human. The user's query is sometimes referred to as an “utterance.” A difficult part of running a chatbot is the interpretation of a user's intent based on the utterance. Another difficult part of running a chatbot is programming the artificial intelligence to choose an appropriate response to the utterance based on the intent. A chatbot serving a broad population, with a broad base of areas where users may be expected to inquire, it may be difficult to make accurate predictions and expectations of the user's intent, and/or to locate the correct answer a wide ranging database of answers. Accordingly, a chatbot that can predict an intent more accurately, and base keyword searching on intent, may be desirable. A chatbot that is aware of who the user is and/or the user's previous activity using the chatbot may also be desirable.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a method for processing user input by a user. The method also includes receiving the user input via a user input interface, where the user input contains a natural language request for information. The method also includes identifying an intent associated with the user input, using a trained natural language processing model on the user input, where the trained natural language processing model may include a transformer model, and where the trained natural language processing model further considers at least a portion of the user's prior user inputs to the chatbot as an input used for identifying the intent. The method also includes using the intent, identifying a domain associated with the user input, where the domain represents a topical focus of the user input. The method also includes identifying abbreviations used in the user input, from a set of abbreviations associated with the domain. The method also includes identifying at least two key words contained in the user input, where identifying at least two key words may include considering whether an identified abbreviation is a key word. The method also includes searching for the key words in a database of potential answers relating to the domain. The method also includes identifying potential answers that are associated with the at least two key words. The method also includes generating a natural language summary of the potential answers. The method also includes outputting the summary to the search interface for display to the user. Other embodiments of this aspect include corresponding computer systems, apparatus, and computer programs recorded on one or more computer storage devices, each configured to perform the actions of the methods.

Implementations may include one or more of the following features. The method where the step of receiving the user input includes using the trained natural language processing model to perform an automatic completion of the user input before the user has finished entering the user input. The step of receiving the user input includes using the natural language processing model to generate one or more recommendations for user input based on having received a portion of the user input. The trained natural language processing model queries the user response database as a part of the step of considering at least a portion of the user's prior user inputs to the search interface. The method may include the step of requesting a second input from the user to indicate whether the summary provided a satisfactory response to the user input. Implementations of the described techniques may include hardware, a method or process, or computer software on a computer-accessible medium.

### BRIEF DESCRIPTION OF THE DRAWINGS

For a better understanding of the various described implementations, reference should be made to the Description of Implementations below, in conjunction with the following drawings in which like reference numerals refer to corresponding parts throughout the figures.

FIG. 1 is a block diagram of a system for machine-learning based search functionality in accordance with one aspect of the present disclosure.

FIG. 2 is a data flow diagram of a system for machine-learning based search functionality in accordance with one aspect of the present disclosure.

FIGS. 3A-3E are exemplars of user interface elements of a dashboard in accordance with one aspect of the present disclosure.

FIGS. 4A and 4B are exemplary graph structures that may be used for searching in accordance with one aspect of the present disclosure.

FIGS. 5A and 5B contain a flow diagram of a method for machine-learning based search functionality in accordance with one aspect of the present disclosure.

### DESCRIPTION OF IMPLEMENTATIONS

Reference will now be made in detail to implementations, examples of which are illustrated in the accompanying drawings. In the following detailed description, numerous specific details are set forth in order to provide a thorough understanding of the various described implementations. However, it will be apparent to one of ordinary skill in the art that the various described implementations may be practiced without these specific details. In other instances, well-known methods, procedures, components, circuits, and networks have not been described in detail so as not to unnecessarily obscure aspects of the implementations.

It will also be understood that, although the terms first, second, etc. are, in some instances, used herein to describe various elements, these elements should not be limited by these terms. These terms are only used to distinguish one element from another. For example, a first electronic device could be termed a second electronic device, and, similarly, a second electronic device could be termed a first electronic device, without departing from the scope of the various described implementations. The first electronic device and the second electronic device are both electronic devices, but they are not necessarily the same electronic device.

The terminology used in the description of the various described implementations herein is for the purpose of describing particular implementations only and is not intended to be limiting. As used in the description of the various described implementations and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting” or “in accordance with a determination that,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event]” or “in accordance with a determination that [a stated condition or event] is detected,” depending on the context.

Customers, employees, vendors, and other constituents of large organizations require access to large and varied quantities of information, e.g., to perform their job within or adjacent to the organization, or to manage their relationship with the organization, e.g., as a customer. A portal is needed to access this information. Portals of a kind known in the art, that contain large quantities of highly varied information that, for example, relate to many different constituencies, may have complex navigation trees or other systems that would make navigation to the information desired difficult to learn and/or time consuming to do frequently and/or repeatedly. For example, such a portal may be used by or within a medical insurance carrier.

Constituencies may include employees of various departments, insureds (e.g., customers, patients), medical providers, e.g., medical practices or hospitals, who may be members of one or more networks associated with the carrier, and/or may submit claims for payment to the carrier, or employees of medical providers. Accordingly, navigation via search engine and/or chatbot may be desirable, to save the time of constituent users who may interact with the portal regularly.

In some embodiments, a portal may be used for customer information, e.g., insight into customer information. In some embodiments, a portal may be used for key performance indicators (“KPIs”), e.g., to browse, bring up, and/or calculate data relating to KPIs. Data may include indicators of progress toward an intended result, e.g., a business result. KPI data may include metrics, which may be associated with an account of a user that is interacting with the portal. The portal may also include transactions that are relevant to a user account or a plurality, e.g., a class, of user accounts.

Due to the massive quantity of KPIs for varied constituencies, a search bar interface utilizing machine learning, herein disclosed, has been devised to simplify navigation and reduce user burden. The back-end of the search functionality may include natural language processing, fuzzy logic, pattern matching, elastic search, answer generation, prompt engineering, text summarization, and text generation, as will be described herein in greater detail.

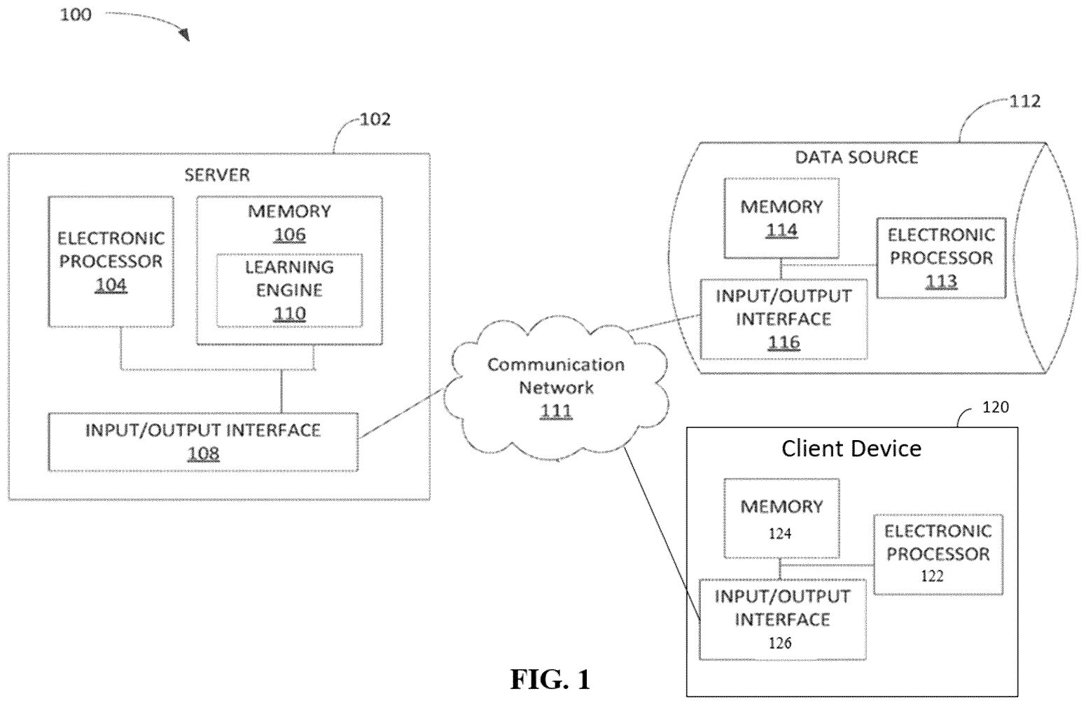

FIG. 1 illustrates a system 100 for creating, running, and serving portal for retrieving information via a chatbot and/or a search engine, enhanced by artificial intelligence, according to some embodiments of the invention. The system 100 includes a server 102 that includes a plurality of electrical and electronic components that provide power, operational control, and protection of the components within the server 102. For example, as illustrated in FIG. 1, the server 102 may include an electronic processor 104 (e.g., a microprocessor, application-specific integrated circuit (ASIC), or another suitable electronic device), a memory 106 (e.g., a non-transitory, computer-readable storage medium), and an input/output interface 108. The electronic processor 104, the memory 106, and the input/output interface 108 communicate over one or more connections or buses. The server 102 illustrated in FIG. 1 represents one example of a server, and embodiments described herein may include a server with additional, fewer, or different components than the server 102 illustrated in FIG. 1. Also, in some embodiments, the server 102 performs functionality in addition to the functionality described herein. Similarly, the functionality performed by the server 102 (i.e., through execution of instructions by the electronic processor 104) may be distributed among multiple servers. Accordingly, functionality described herein as being performed by the electronic processor 104 may be performed by one or more electronic processors included in the server 102, external to the server 102, or a combination thereof.

The memory 106 may include read-only memory (“ROM”), random access memory (“RAM”) (e.g., dynamic RAM (“DRAM”), synchronous DRAM (“SDRAM”), and the like), electrically erasable programmable read-only memory (“EEPROM”), flash memory, a hard disk, a secure digital (“SD”) card, other suitable memory devices, or a combination thereof, which may include transitory memory, non-transitory memory, or both. The electronic processor 104 executes computer-readable instructions (“software”) stored in the memory 106. The software may include firmware, one or more applications, program data, filters, rules, one or more program modules, and other executable instructions. For example, the software may include instructions and associated data for performing the methods described herein. For example, as illustrated in FIG. 1, the memory 106 may store an artificial intelligence software module (e.g., “software”) 110 for performing one or more of the functions described herein, which may include natural language processing, fuzzy logic, answer generation, keyword extraction, prompt engineering, intent recognition, machine learning, artificial intelligence, text summarization, or the like. However, in other embodiments, the functionality described herein as being performed by the chatbot module 110 may be performed through one or more software modules stored in the memory 106 or external memory.

The input/output interface 108 allows the server 102 to communicate with devices external to the server 102. For example, as illustrated in FIG. 1, the server 102 may communicate with one or more data sources 112 through the input/output interface 108. In particular, the input/output interface 108 may include a port for receiving a wired connection to an external device (e.g., a universal serial bus (“USB”) cable and the like), a transceiver for establishing a wireless connection to an external device (e.g., over one or more communication networks 111, such as the Internet, a local area network (“LAN”), a wide area network (“WAN”), and the like), or a combination thereof.

In some embodiments, the server 102 also receives input from one or more peripheral devices, such as a keyboard, a pointing device (e.g., a mouse), buttons on a touch screen, a scroll ball, mechanical buttons, and the like through the input/output interface 108. Similarly, in some embodiments, the server 102 provides output to one or more peripheral devices, such as a display device (e.g., a liquid crystal display (“LCD”), a touch screen, and the like), a printer, a speaker, and the like through the input/output interface 108. In some embodiments, output may be provided within a graphical user interface (“GUI”) (e.g., generated by the electronic processor 104 executing instructions and data stored in the memory 106 and presented on a touch screen or other display) that enables a user to interact with the server 102. In other embodiments, a user may interact with the server 102 through one or more intermediary devices, such as a personal computing device, e.g., laptop, desktop, tablet, smartphone, smartwatch or other wearable device, smart television, and the like. For example, a user may configure functionality performed by the server 102 as described herein by providing data to an intermediary device that communicates with the server 102. In particular, a user may use a browser application executed by an intermediary device to access a web page that receives input from and provides output to the user for configuring the functionality performed by the server 102.

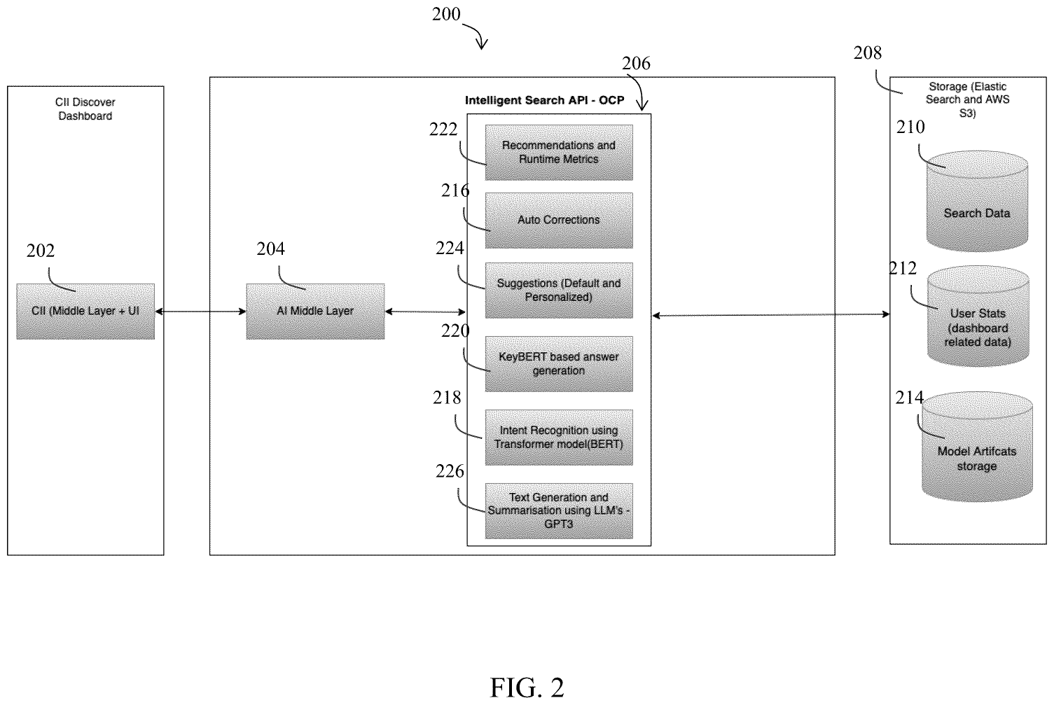

As illustrated in FIG. 1, the system 100 includes one or more data sources 112. Each data source 112 may include a plurality of electrical and electronic components that provide power, operational control, and protection of the components within the data source 112. In some embodiments, each data source 112 represents a server, a database, a personal computing device, or a combination thereof. For example, as illustrated in FIG. 1, each data source 112 may include an electronic processor 113 (e.g., a microprocessor, ASIC, or other suitable electronic device), a memory 114 (e.g., a non-transitory, computer-readable storage medium), and an input/output interface 116. The data sources 112 illustrated in FIG. 1 represent one example of data sources and embodiments described herein and may include a data source with additional, fewer, or different components than the data sources 112 illustrated in FIG. 1. Also, in some embodiments, the server 102 communicates with more or fewer data sources 112 than illustrated in FIG. 1. Data source 112 may include a storage layer, e.g., storage layer 208 as discussed in more detail below with reference to FIG. 2.

The input/output interface 116 allows the data source 112 to communicate with external devices, such as the server 102. For example, as illustrated in FIG. 1, the input/output interface 116 may include a transceiver for establishing a wireless connection to the server 102 or other devices through the communication network 111 described above. Alternatively or in addition, the input/output interface 116 may include a port for receiving a wired connection to the server 102 or other devices. Furthermore, in some embodiments, the data sources 112 also communicate with one or more peripheral devices through the input/output interface 116 for receiving input from a user, providing output to a user, or a combination thereof. In other embodiments, one or more of the data sources 112 may communicate with the server 102 through one or more intermediary devices. Also, in some embodiments, one or more of the data sources 112 may be included in the server 102.

The memory 114 of each data source 112 may store data, such as a chatbot database and the like. In some embodiments, as noted above, data stored in the data sources 112 or a portion thereof may be stored locally on the server 102 (e.g., in the memory 106).

User device 120 may also be connected to communication network 111, for communication with server 102 and/or with data source 112. Inputs and outputs 118 may flow between server 102, e.g., via input/output interface 108, and user device 120, e.g., via input/output interface 126. Inputs may include chatbot interactions and input test files as described herein below. Outputs may include natural language processing and data analysis, e.g., as performed by a chatbot application programming interface (“API”), as described in more detail below.

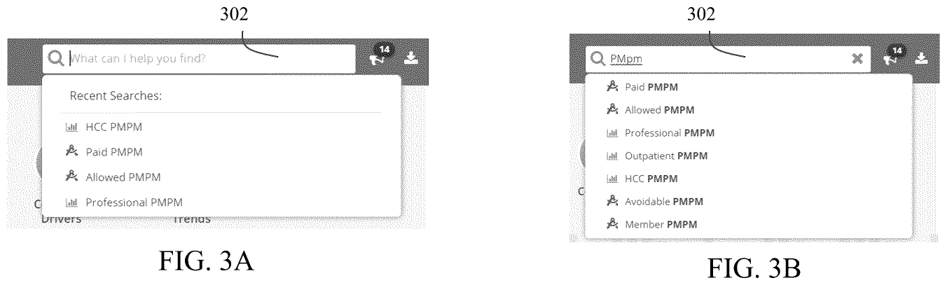

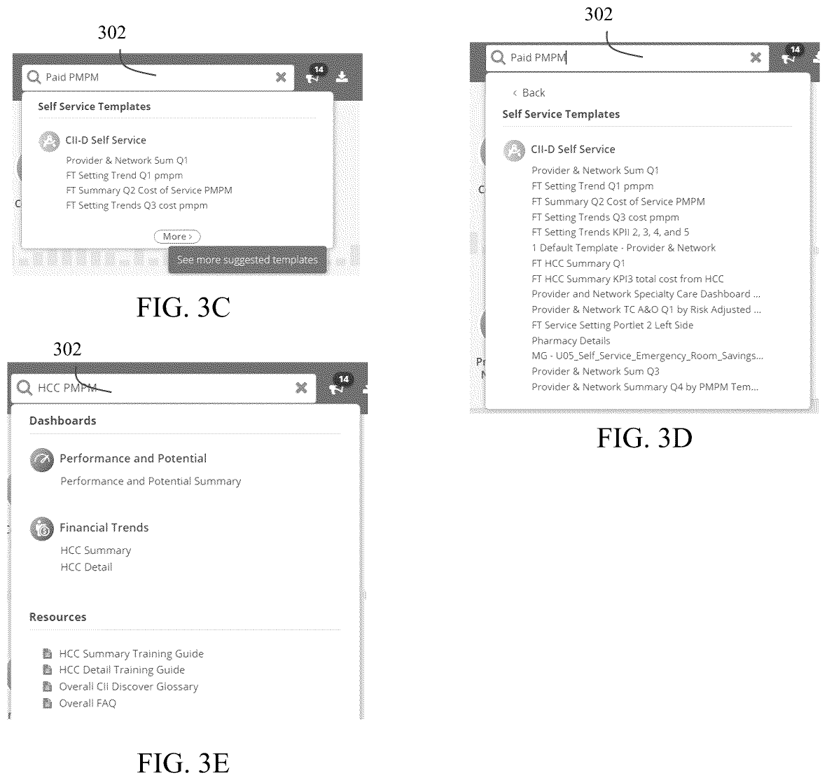

Turning now to FIG. 2, a data flow diagram of a system 200 in accordance with one embodiment of the present disclosure is shown. A user query may first be received at a user interface layer 202. An example of a user interface that may be implemented by user interface layer 202 is shown in FIG. 3A through 3E, as discussed in more detail below, by which a user may interact with the portal's dashboard user interface 300 via user interface layer 202. User interface 300 may include a user input field 302, which may be a text entry box as shown. The user query may be received, e.g., via user input, which may be via a user input device such as a keyboard, or via voice e.g., with a microphone. A user input received via voice may be converted to text for further processing.

User interface layer 202 may also be described as a middle layer, and may also be described as a dashboard layer. User interface layer 202 may implement other dashboard user interface elements in addition to a search engine. Other user interface elements may include alternative methods of navigation for results similar to those delivered by the search engine, such as, e.g., KPI metrics.

The user query may then be passed to an natural language artificial intelligence processor 204 for further processing. The user query may be presumed to have been received in a natural language, and may need to be processed, e.g., parsed and interpreted, by natural language artificial intelligence processor 204. Natural language artificial intelligence processor 204 may parse and interpret the user input by performing any of the following operations, no single one of which is necessary for the operation of the invention. Natural language artificial intelligence processor 204 may in some embodiments detect or identify which natural language the user input contains. In some embodiments, natural language artificial intelligence processor 204 may also correct misspellings in the user input. In some embodiments, natural language artificial intelligence processor 204 may, e.g., preliminarily, eliminate words or phrases from the user input that are determined to be unnecessary for the further processing of the user input by intelligent search layer 206 as described below.

In some embodiments, recommendations may be presented to the user, as shown in FIG. 3A. Recommendations may include popular searches on the platform generally, and may also include previous searches made by that user. Recommendations may also include popular searches by users similar to the current user, such as users in the same role with the company.

Once a user has begun inputting, e.g., typing, a query, suggestions may be presented to the user. Suggestions may take the form of auto-completed suggested queries as shown in FIG. 3B. Suggestions may also take the form of self-service navigation options, such as templates as shown in FIG. 3D or dashboards and/or other resources as shown in FIG. 3E. Default suggestions and/or personalized suggestions may be generated by suggestions module 224 of FIG. 2.

In some embodiments, natural language artificial intelligence processor 204 may contain a model that is trained and refined over time, using a corpus of training data. The corpus of training data may include membership details relating to a user or a group of users. Membership details may include a sub-category of risk score. Risk scores may in turn include a health risk score, a health risk score categorized by location, e.g., by state, or by core-based statistical area (CBSA). Training data may also include membership information, which may include information relating to membership in a health insurance plan. Training data may also include condition drivers. Training data may also include Per Member Per Month, or PMPM, metrics. PMPM metrics may include medical PMPM cost, medical PMPM utilization. PMPM data may also be categorized or sorted by diagnostic categories. In some embodiments, PMPM metrics may be used as summaries, or in detail e.g., for a particular patient, or both. Use of training data, such as that listed above, may train the model to become more efficient at calculating metrics when similar data is requested by a user.

Natural language artificial intelligence processor 204 may then include, and/or may send data to and/or receive data from, intelligent search layer 206. Intelligent search layer 206 may be implemented as an application programming interface (“API”). Intelligent search layer may include auto corrections, intent recognition, keyword generation, recommendations, runtime metrics, suggestions, and text generation, as discussed in further detail below with reference to elements 216-226 of FIG. 2. In some embodiments, some of the functions of intelligent search layer 206, or its constituent parts as described below, may use and/or otherwise call upon natural language artificial intelligence processor 204. Accordingly, natural language artificial intelligence processor 204 may assist in keyword detection, intent classification, and/or text generation, as described in further detail below.

Intelligent search layer 206 may send data to and receive data from storage layer 208. Storage layer 208 may contain multiple types of data, which may be stored in separate databases as shown in FIG. 2, but may also be stored in more or fewer than the three databased depicted herein. Storage layer 208 may include search data 210, which may include the core substantive data, which will be searched for answers to the user query. Search data 210 may include KPI data and metrics. Storage layer 208 may also include user statistics 212. User statistics 212 may include prior searches histories, via the dashboard, which prior search history may include a link or other association between the text of the search and the user who initiated the search. Storage layer 208 may also include model artifacts 214. Model artifacts 214 may be, or have been output by the training process. A model artifact may include a model, a model checkpoint for resuming training at a later time, or a file created by the training process, such as an image. In some embodiments, model artifacts 214 may encapsulate generalized learning from a subset of training samples. In some embodiments, model artifacts 214 may also allow the system to better understand the context of a user query, and to provide a similar query match. Model artifacts may be used to teach the model to recognize sentence structures or other similarities between query sentences and other sentences upon which the model has been trained.

Intelligent search layer 206 may include auto corrections module 216, which may be used, e.g., as a preliminary step, to correct errors in the user query, such as typographical errors, misspellings, and the like. Auto corrections module 216 may also include autocomplete for searches. Autocomplete may suggest words or phrases to the user, to complete the user's query without having to type the entire query. Autocomplete may generate suggestions from information relating to the user, including the user's prior inquiries, which may be derived from user statistics database 212, may provide relevant suggestions because an individual user may make similar searches multiple times. Autocomplete may also generate suggestions from frequently used terms, e.g., by the user and/or in the search interface by all users. Autocomplete may also generate suggestions from one or more dictionaries or other databases of terms, which may include databases relating to terms known to relate to a set of domains for which the search interface is frequently used. In some embodiments, a database of terms may be refined over time, e.g., via saving searches for later reference. Saved searches may be used as training data, e.g., for natural language artificial intelligence processor 204.

Once the user query has been auto corrected, intent recognition model 218 may then be implemented. Intent recognition model 218 may include a transformer model, and may be implemented using a pretrained natural language processing model such as Bidirectional Encoder Representations from Transformers (“BERT”). Intent recognition model 218 may use the transformer model to recognize an intent of the user, from the query.

Intent recognition via intent recognition model 218 may include recognizing a domain of a user query. A domain, as that term is used herein, may relate to a category or subcategory of business specific data, such as patient records, insurance claims, internal business metrics, or the like. Intent recognition model 218 may use user statistics 212 from storage layer 208, to use identified domains from the user's previous queries to identify a domain of the present user query. In this way, the user's prior search history is used, along with the content of the query, to identify the user's intent. In some embodiments, a user's prior search history may be used, but other identifying information about the user, e.g., from the user's account, may not be used to recognize a user's intent. However, account information, such as information identifying a user's role within an organization, may be used for other purposes, such as management of access to certain information, e.g., within search data 210, or for prompting.

Intelligent search layer 206 may also contain keyword module 220, which may be used to identify keywords from the user query. Keyword module 220 may be implemented using KeyBERT, which is a is a keyword extraction technique that leverages BERT embeddings to identify keywords and key phrases that are most similar to a string of natural language text, such as a document or a user query.

Keyword module 220 may also include prompt engineering. Prompt engineering may include abbreviation recognition functionality. Once a domain has been identified for the query, e.g., via intent recognition model 218, domain specific abbreviation databases may be accessed when further evaluating the query. Associating a query with a domain, with domain specific abbreviations, allows intent recognition model 218 and keyword module 220 to include expanded definitions of abbreviations that may be used in the query, which may be specific to the identified domain. This is an improvement over known search engines, which do not engage in domain identification, and therefore are not able to confidently use abbreviation definitions or expansions in evaluating natural language to identify keywords or classify intent.

The same abbreviation may have entirely different definitions in different domains. For example, the abbreviation “ABA” may stand for Applied Behavior Analysis in one domain, American Bar Association in another domain, and American Basketball Association in a third domain. Generally applicable search engines, such as Google, Bing, and the like, would have to search for and consider results relating to all of the possible expanded meanings of an abbreviation that appears in a search. However, if, for example, the same user has a prior search history relating to autism spectrum disorder, that domain may be identified, and then the appropriate expanded definition of “ABA” may be evaluated by the model and used for querying. Accordingly, identifying the domain, e.g., by using previous queries by the same user and domains associated therewith, will permit intent recognition model 218 and/or keyword module 220 to use the appropriate expanded abbreviation associated with the identified domain.

Once a domain is recognized, and domain-specific abbreviations are recognized and expanded, keyword module 220 may then use the user query, enhanced by domain specific abbreviation detection, to identify keywords from the user query, upon which a database query may be based. Keyword detection module 218 may also use the identified domain to identify, within the user query, words that are known, from prior searches, as being keywords associated with the identified domain. In some embodiments, keyword detection module 218 may include an artificial intelligence model, which may be trained and refined based on identifying keywords that are associated with particular domains.

Some user queries may be interpreted as asking for an answer that may require a manipulation of data that may be in search data 210. A manipulation may also be referred to as a runtime metric, and may include various mathematical operations or calculations, or other kinds of real time analysis, which may be required to present an answer to the user query that conforms with what the user has requested. User queries that require runtime metrics may be passed to recommendations and runtime metrics module 222, which may determine from the query what runtime metrics may need to be performed in order to transform data from search data 210 into the format or context that the user requested. In some embodiments, search data 210 may contain metrics that may be used to create runtime metrics in accordance with the user query.

Answers may be based on the keywords identified by keyword detection module 218. In some embodiments, answers may be generated by searching search data 210 for the identified keywords. In some embodiments, a query with multiple identified keywords may result in the generation of potential answers by searching for each keyword and then filtering out potential suggestions by keeping only those that match all identified keywords. In some embodiments, information such as a user's role or access permissions may be used to restrict access to certain of the potential answers.

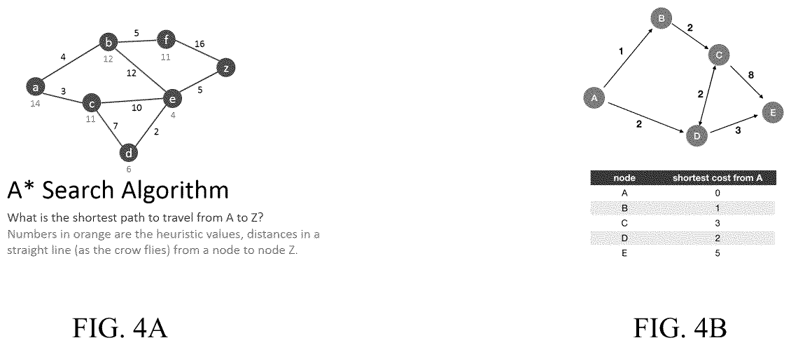

In some embodiments, data from search data 210 may be searched using a graph. In some embodiments, a sub graph may be extracted for the metrics the role is authorized to access and get information. In some embodiments, the sub graph may be searched for the exact metric the user is querying, and a frequency of them may also be found. If the frequency is 1 then the identified metric may be directly fetched, and the system may then respond by presenting that metrics to the user appropriately. If the frequency is more than 1, and there is more than one match, then the system may then navigate to the shortest path to that metric from a perspective relating to the user's role, and identify the requested metrics. In some embodiments, a metric search in this graph structure may be done using and A* Search algorithm to preserve optimal navigation. An exemplar of a graph for use with an A* Search algorithm is shown in FIG. 4A. Specific role node may be searched and the graph may be traverses based on the search criteria. In some embodiments, a shortest path along a graph may be found using a Bellman-Ford algorithm. An exemplar of a graph for use in a Bellman-Ford algorithm is shown in FIG. 4B.

Because the data in search data 210 is dynamic and changing from time to time, the graph structure may be updated from time to time. Updates may include reindexing the relevant attributes, and maintaining the search algorithm such that it remains up-to-date with the latest changes.

Automatic prompting may then be used to evaluate the search result, e.g., for accuracy. In some embodiments, automatic prompting may begin with getting the query from user input. Stop words may then be removed from the query. Abbreviations may then be evaluated. If a word is not an abbreviation, spell check may then be applied. If a words is an abbreviation, multiple strings including the abbreviated and non-abbreviated forms of the abbreviated word in the query may be added to the query. For example, is a user types “Inpatient PMPM,” text may be generated that relates to the meaning of the abbreviation. Generated text, from this step, may include Inpatient PMPM, IP PMPM, IP Per member per month, Inpatient per member per month.

Fuzzy match searching may then be applied to the modified query. Once the data for the possibly query texts are obtained, they may be combined into an output and de-duplicated. Words in the query may then be converted into Base form, which may be done using lemmatization. A copy of questions generated from elastic search may then be received and converted to base form. Original words which matches the base form of user query, may then be shown to the user as highlighted.

Text generation and summarization module 226 may then transform the results of the database queries, after filtering for keywords, into a natural language text answer, that may then be presented to the user in a text format, e.g., via user interface 300. In some embodiments, text generation and summarization module 226 may create a single natural language answer from multiple search result hits. Accordingly, the user is presented with a single comprehensive answer, rather than five search result hits.

In one example of intent classification, domain identification, key word identification, suggestion generation, text generation, and summarization, a user may queries the search engine “what is a medication for diabetes.” Natural language artificial intelligence processor 204 may first intent classification. This may include identifying the domain of the query, which in this instance may be identified as care provider information. Once a domain is identified, keywords may then be extracted by keyword detection module 218. Keywords from this query may include “medication” and “diabetes.” Diabetes may then be identified as a “condition.” Suggestions module 224 may then generate a suggestion by searching data, e.g., in search data 210. on “medication” and “diabetes.” Text generation and summarization module 226 may then combine the suggestions into a summary answer, which may then be output to the user, e.g., via the user interface.

In some embodiments, the user may then be asked for feedback on whether the results are sufficient, which may be provided by a user interface elements such as thumbs up/thumbs down icons. In some embodiments, the results of that user feedback may be stored, e.g., in user statistics 212, and evaluated for future responses.

In some embodiments, assessments may then be performed. Assessment is a process for obtaining user feedback on the recommendations, suggestions, and answers, to evaluate the relevancy of the responses either with icons thumbs up/down or 5 stars ratings for improving the algorithm future responses. In some embodiments, sensitivity of a recommendation may also be evaluated.

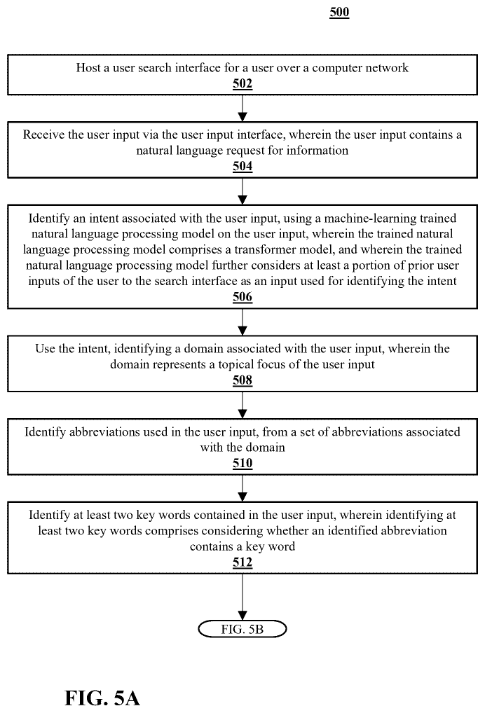

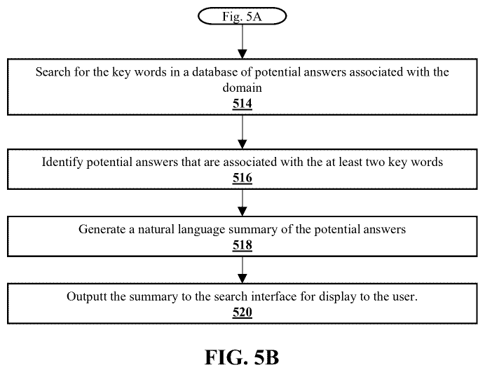

Turning now to FIGS. 5A and 5B, wherein a flow diagram of a method 500 for machine-learning based search functionality in accordance with one aspect of the present disclosure is disclosed. In method 500, a search user interface, e.g., user interface layer 202, is hosted (502) for a user over a computer network. A user input is then received (504), e.g., at the search interface. The user input may contain a natural language request for information. Receiving (514) the user input may include using a trained natural language processing model, e.g., natural language artificial intelligence processor 204, to perform an automatic completion of the user input before the user has finished entering the user input. Receiving the user input may also include using the natural language processing model to generate one or more recommendations for user input based on having received a portion of the user input.

An intent may then be identified (506). The intent may be associated with the user input. The intent identification (506) may be performed using a machine learning trained natural language processing model, e.g., using intent recognition model 218, on the user input. The trained natural language processing model may also consider at least a portion of prior user inputs of the user to the search interface as an input used for identifying the intent. In some embodiments, user input, associated with data relating to the user, may be saved in a user response database, such as user statistics database 212, e.g., each time the user enters a new user input. The trained natural language processing model may query the user response database as a part of the step of considering at least a portion of the user's prior user inputs to the search interface.

A domain, associated with the user input, may then be identified (508), using the intent. As discussed above, a domain may represent a topical focus of the user input, such a category or subcategory of business specific data, such as patient records, insurance claims, internal business metrics, or the like. Abbreviations, present in the user input, may then be identified (510). The abbreviations may be identified from a set of abbreviations associated with the domain.

Keywords may then be identified (512), e.g., by the keyword detection module 218. In some embodiments, multiple keywords may be identified, e.g., at least two key words. In some embodiments, key word identification may consider the abbreviations identified (510) to determine whether the abbreviations may contain, e.g., may stand for, a key word.

Key words may then be searched (514) in a database of potential answers associated with the domain, e.g., search data 210. Potential answers may then be identified (516). In some embodiments, potential answers may be chosen only among answer that are associated with both, and/or all, of the identified key words. A natural language summary of the identified potential answers may be generated (518), e.g., by text generation and summarization module 226. Text generation may in some embodiments include combining multiple answers into a single, cohesive natural language summary. The natural language summary may then be output (520), e.g., to the search interface. In some embodiments, a second input may be requested from the user, to indicate whether the summary provided a satisfactory response to the user input.

The foregoing description, for purpose of explanation, has been described with reference to specific implementations. However, the illustrative discussions above are not intended to be exhaustive or to limit the scope of the claims to the precise forms disclosed. Many modifications and variations are possible in view of the above teachings. The implementations are chosen in order to best explain the principles underlying the claims and their practical applications, to thereby enable others skilled in the art to best use the implementations with various modifications as are suited to the particular uses contemplated.

What is claimed is:

1. A computer-implemented method for processing user input by a user, and generating a response, via a search interface utilizing machine learning, comprising:
hosting a user search interface for a user over a computer network;
receiving the user input via the user search interface, wherein the user input contains a natural language request for information;
identifying an intent associated with the user input, using a machine-learning trained natural language processing model on the user input, wherein the trained natural language processing model comprises a transformer model, and wherein the trained natural language processing model further considers at least a portion of prior user inputs of the user to the search interface as an input used for identifying the intent;
identifying a domain associated with the user input based on the intent by:
traversing a graph data structure comprising nodes representing domains and edges representing relationships between the domains, wherein each domain represents a category of business-specific data selected from patient records, insurance claims, and business metrics, and
selecting a domain node from the graph data structure based on the identified intent;
accessing, from a database storing domain-specific abbreviation mappings, a set of abbreviation definitions associated with the selected domain node;
expanding abbreviations used in the user input by replacing the abbreviations with their corresponding definitions from the accessed set of abbreviation definitions;
identifying at least two keywords contained in the user input based on the expanded abbreviations;
searching the graph data structure using an A* search algorithm to:
identify nodes containing potential answers associated with the selected domain node and the at least two keywords, and
determine a shortest path to each identified answer node;
updating the graph data structure in response to detecting changes in stored relationships between domain nodes, abbreviation mappings, and answer nodes;
generating a natural language summary that combines the potential answers identified from the answer nodes into a single response; and
outputting the natural language summary to the search interface for display to the user.

2. The method of claim 1, wherein the step of receiving the user input includes using the trained natural language processing model to perform an automatic completion of the user input before the user has finished entering the user input.

3. The method of claim 1, wherein the step of receiving the user input includes using the trained natural language processing model to generate one or more recommendations for user input based on having received a portion of the user input.

4. The method of claim 1, further comprising the step of saving the user input, associated with data relating to the user, in a user response database, wherein the trained natural language processing model queries the user response database as a part of the step of considering at least a portion of the user's prior user inputs to the search interface.

5. The method of claim 1, further comprising the step of requesting a second input from the user to indicate whether the natural language summary provided a satisfactory response to the user input.

6. The method of claim 1, wherein the trained natural language processing model comprises a transformer model.

7. A computer readable medium containing instructions that, when executed by a processor, cause the processor to perform a method for processing user input by a user, and generating a response, via a search interface utilizing machine learning, the method comprising the steps of:
hosting a user search interface for a user over a computer network;
receiving the user input via the user search interface, wherein the user input contains a natural language request for information;
identifying an intent associated with the user input, using a machine-learning trained natural language processing model on the user input, wherein the trained natural language processing model considers at least a portion of prior user inputs of the user to the user search interface as an input used for identifying the intent;
identifying a domain associated with the user input based on the intent by:
traversing a graph data structure comprising nodes representing domains and edges representing relationships between the domains, wherein each domain represents a category of business-specific data selected from patient records, insurance claims, and business metrics, and
selecting a domain node from the graph data structure based on the identified intent;
accessing, from a database storing domain-specific abbreviation mappings, a set of abbreviation definitions associated with the selected domain node;
expanding abbreviations used in the user input by replacing the abbreviations with their corresponding definitions from the accessed set of abbreviation definitions;
identifying at least two keywords contained in the user input based on the expanded abbreviations;
searching the graph data structure using an A* search algorithm to:
identify nodes containing potential answers associated with the selected domain node and the at least two keywords, and
determine a shortest path to each identified answer node;
updating the graph data structure in response to detecting changes in stored relationships between domain nodes, abbreviation mappings, and answer nodes;
generating a natural language summary that combines the potential answers identified from the answer nodes into a single response; and
outputting the natural language summary to the user search interface for display to the user.

8. The medium of claim 7, wherein the trained natural language processing model comprises a transformer model.

9. The medium of claim 7, wherein the step of identifying a keyword comprises identifying at least two key words, and wherein the step of identifying potential answers that are associated with the key word comprises identifying potential answers that are associated with both of the at least two key words.

10. The medium of claim 7, wherein the step of receiving the user input includes using the trained natural language processing model to perform an automatic completion of the user input before the user has finished entering the user input.

11. The medium of claim 7, wherein the step of receiving the user input includes using the trained natural language processing model to generate one or more recommendations for user input based on having received a portion of the user input.

12. The medium of claim 7, wherein the method further comprises the step of saving the user input, associated with data relating to the user, in a user response database, wherein the trained natural language processing model queries the user response database as a part of the step of considering at least a portion of the user's prior user inputs to the user search interface.

13. The medium of claim 7, wherein the method further comprises the step of requesting a second input from the user to indicate whether the natural language summary provided a satisfactory response to the user input.

14. A system, comprising:
a non-transitory memory;
a processor communicatively coupled to the non-transitory memory, wherein the processor is configured to read a set of instructions to:
host a user search interface for a user over a computer network;
receive the user input via the user search interface, wherein the user input contains a natural language request for information;
identify an intent associated with the user input, using a machine-learning trained natural language processing model on the user input, wherein the trained natural language processing model considers at least a portion of prior user inputs of the user to the user search interface as an input used for identifying the intent;
identify a domain associated with the user input based on the intent by:
traverse a graph data structure comprising nodes representing domains and edges representing relationships between the domains, wherein each domain represents a category of business-specific data selected from patient records, insurance claims, and business metrics, and
select a domain node from the graph data structure based on the identified intent;
access, from a database storing domain-specific abbreviation mappings, a set of abbreviation definitions associated with the selected domain node;
expand abbreviations used in the user input by replacing the abbreviations with their corresponding definitions from the accessed set of abbreviation definitions;
identify at least two keywords contained in the user input based on the expanded abbreviations;
search the graph data structure using an A* search algorithm to:
identify nodes containing potential answers associated with the selected domain node and the at least two keywords, and
determine a shortest path to each identified answer node;
update the graph data structure in response to detecting changes in stored relationships between domain nodes, abbreviation mappings, and answer nodes;
generate a natural language summary that combines the potential answers identified from the answer nodes into a single response; and
output the natural language summary to the user search interface for display to the user.

15. The system of claim 14, wherein the trained natural language processing model comprises a transformer model.

16. The system of claim 14, wherein the step of identifying a keyword comprises identifying at least two key words, and wherein the step of identifying potential answers that are associated with the key word comprises identifying potential answers that are associated with both of the at least two key words.

17. The system of claim 14, wherein the step of receiving the user input includes using the trained natural language processing model to perform an automatic completion of the user input before the user has finished entering the user input.

18. The system of claim 14, wherein the step of receiving the user input includes using the trained natural language processing model to generate one or more recommendations for user input based on having received a portion of the user input.

19. The system of claim 14, wherein the processor is further configured to read a set of instructions to save the user input, associated with data relating to the user, in a user response database, wherein the trained natural language processing model queries the user response database as a part of the step of considering at least a portion of the user's prior user inputs to the user search interface.

20. The system of claim 14, wherein the processor is configured to read a set of instructions to request a second input from the user to indicate whether the natural language summary provided a satisfactory response to the user input.
